(19) United States
(12) Patent Application Publication
(10) Pub. No.: US 2004/0199537 A1
(43) Pub. Date: Oct. 7, 2004

(54) System for storing and retrieving database information

(76) Inventor: Robert Cory Duff, Issaquah, WA (US)

Correspondence Address: Alexander J. Burke, Intellectual Property Department 5th Floor, 170 Wood Avenue South, Iselin, NJ, 08830, US

(21) Appl. No.: 10/756,527

(22) Filed: Jan. 13, 2004

Related U.S. Application Data
(60) Provisional application No. 60/460,033, filed on Apr. 3, 2003.

(51) Int. Cl. G06F 17/00

(52) U.S. Cl. 707/102

(57) ABSTRACT

Certain exemplary embodiments comprise a system for storing information in a repository. The system comprises an interface processor for receiving a text file comprising a plurality of records containing data in a character string representative data format. The system further comprises a pre-processor for parsing a reference file to determine relationships between records comprised of character strings in the text file, the relationships comprising a key relationship, and for storing data identifying the relationships in memory. The system further comprises a data processor for storing the records comprised of the character strings in the text file in a repository using the data identifying the relationships.

### CROSS-REFERENCE TO RELATED APPLICATIONS

This application claims priority to pending provisional application Serial No. 60/460,033 (Applicant Docket No. 03P04909US), filed Apr. 3, 2003.

### BACKGROUND

Known systems parse and process records received from remote sources at load time. They would also have to have many database schemas to accommodate the many record formats to be imported. Prior solutions for remote data storage are modular and disconnected because a new solution is created for each imported database. Consequently, known systems perform large amounts of unneeded parsing and processing and require multiple complex schemas to accommodate incoming data formats.

A typical database is constructed using a unique schema and particular database standard. Once constructed, a database is capable of being queried in accordance with the particular database standard underlying the database. It is desirable to be able to combine a plurality of databases, each with a unique schema, created by the same or different database standards. It is desirable to be able to combine databases without processing each individual record, yet allowing combined databases to still be searched. Known systems do not provide this functionality.

A system according to the principles of the invention addresses the identified deficiencies and associated problems.

### SUMMARY

Certain exemplary embodiments comprise a system for storing information in a repository. The system comprises an interface processor for receiving a text file comprising a plurality of records containing data in a character string representative data format. The system further comprises a pre-processor for parsing a reference file to determine relationships between records comprised of character strings in the text file, the relationships comprising a key relationship, and for storing data identifying the relationships in memory. The system further comprises a data processor for storing the records comprised of the character strings in the text file in a repository using the data identifying the relationships.

### DESCRIPTION OF THE DRAWINGS

The invention and its wide variety of potential embodiments will be more readily understood through the following detailed description, with reference to the accompanying drawings in which:

FIG. 1 is a block diagram of an exemplary embodiment of a system 1000;

FIG. 2 is a flow diagram of an exemplary embodiment of a method of use 2000 for processing a text file;

FIG. 3 is a flow diagram of an exemplary embodiment of a method of use 3000 for converting a database file to a text file;

FIG. 4 is a flow diagram of an exemplary embodiment of a method of use 4000 for converting a text file to a composite database file; and

FIG. 5 is a flow diagram of an exemplary embodiment of a method of use 5000 for merging a text file into a composite database file;

FIG. 6 is a block diagram of an exemplary embodiment of a system 6000;

FIG. 7 is a block diagram of an exemplary embodiment of an information device 7000;

FIG. 8 is a schema of an exemplary embodiment of a data repository;

FIG. 9 is a description of fields of various tables of the schema of FIG. 8;

FIG. 10 is a flow diagram of an exemplary embodiment of a storage procedure;

FIG. 11 is a flow diagram of an exemplary embodiment of a retrieval procedure;

FIG. 12 is a list of exemplary data for the schema of FIG. 8;

FIG. 13 is an exemplary embodiment of software code for implementing a data search procedure; and

FIG. 14 is an exemplary embodiment of software code for implementing a data population procedure.

### DETAILED DESCRIPTION

As used herein, the term “composite database file” means a database file created from a text file comprising character strings. Each character string from the text file is created by combining data elements from a record of an original database. The composite database file comprises all the character strings of a text file.

As used herein, the term “composite database structure file” means a file comprising information about the composite database file, such as information about the number of data elements in a record, the size of data elements in a record, the number of records in an original database, a primary key from an original database, a foreign key from an original database, etc.

As used herein, the term “database” means a structured collection of data. A database comprises one or more files, each file is structured as a group of records, each record containing related data elements that are stored in pre-defined fields.

As used herein, the term “database file” means a file comprising a collection of related data stored in a structured format. A database file comprises records.

As used herein, the term “database standard” means any system supporting the formation and use of a database. Database standards comprise Microsoft SQL, Microsoft Access, MYSQL, Oracle, FileMaker, Sybase, and/or DB2, etc.

As used herein, the term “field” means a storage space for a type of data element. Fields contain textual, numeric, date, graphical, audio, video, and/or calculated data elements. Any text field has properties comprising a fixed or variable length, a pre-defined display format, and/or relatability to another field.

As used herein, the term “information device” means any processing device (in software or hardware) capable of processing information, such as any general purpose and/or special purpose computer, such as a personal computer, workstation, server, minicomputer, mainframe, supercomputer, computer terminal, laptop, wearable computer, and/or Personal Digital Assistant (PDA), etc.

As used herein, the term “key” means a field usable to sort data. In certain exemplary embodiments, a “key” is also called a key field, sort key, index, or key word. For example, if records are sorted by age, then the age field is a key. Most database standards allow more than one key so that records are sortable in different ways. One of the keys, designated the primary key, holds a unique value for each record. A key field that identifies records in a different table is called a foreign key.

As used herein, the term “metadata” means data about data. Metadata describes, for example, how, when, and/or by whom a particular set of data was collected, and/or how the data is formatted, communicated, or protected.

As used herein, the term “processor” means any device and/or set of machine-readable instructions adaptable to perform a specific task. A processor comprises any one or combination of hardware, firmware, and/or software adaptable to perform a specific task. A processor acts upon information by manipulating, analyzing, modifying, converting, transmitting the information to an information device, and/or routing the information to an output device. A processor resides on and use the capabilities of a controller.

As used herein, the term “record” means a collection of data elements. For example, a personnel file might contain records that have data elements stored in three fields: a name field, an address field, and a phone number field. A group of records forms a database.

As used herein, the term “reference file” means a file containing metadata describing the attributes of the contents of a text file, that content arranged in the text file as a single character string comprising combined data elements of at least one record of the database. The metadata contained in the reference file describes, for example, field names, field lengths, the number of data elements in a record, the number of records in the text file, a primary key, a foreign key, etc.

As used herein, the term “rendered” means made perceptible to a human, for example as data, commands, text, graphics, audio, video, animation, and/or hyperlinks, etc., such as via any visual and/or audio means, such as via a display, a monitor, electric paper, an ocular implant, a speaker, a cochlear implant, etc.

As used herein, the term “repository” means a device or database in which data is stored.

As used herein, the term “schema” means the structure of a database system, described in a formal language supported by a database standard. In a relational database, the schema defines the records, the fields in each record, and the relationships between fields and records. Schemas are generally stored in a data dictionary. Although a schema is defined in text database language, the term is often used to refer to a graphical depiction of the database structure.

As used herein, the term “text file” means a file comprising character strings.

As used in the claims, each character string comprises combined data elements from a record.

As used herein, the term “user interface” means any device accessible to the user comprising at least one user interface elements. As used herein, the term “user interface elements” means at least one of a plurality of fields rendering information and/or requesting information from the user.

An exemplary embodiment of a database structure is used to store and retrieve data from remote sources, regardless of the content and format of that data, while maintaining relationships (e.g., primary key/foreign key relationships) between imported records. The imported data is largely neither parsed nor processed on import, and is stored in its original form to reduce data loss. This enables the data received from the remote source to be available for retrieval.

The system includes a database design storing data from remote sources. The system accommodates a wide range of data formats, even if there are multiple types of records, with relationships between them. This is achieved by loading the data records as a text string and incorporating metadata that describes key aspects of the data i.e. key/foreign key locations within the string. This alleviates the need for the substantial parsing and processing that occurs in known systems upon the load of data. It also makes the system flexible since many formats of data can be stored within one structure.

In certain exemplary embodiments, search and retrieval of the data is facilitated by defining elements within the records identifiable upon a search. These elements are then pulled out and stored separately. The system addresses the problem of requiring multiple database structures to store many different record formats as well as the burden of performing substantial processing of records at load time. In contrast, the system removes the need to process substantially all the data at load time. The system processes the data at time of retrieval.

Further, the system supports a simple schema to accommodate multiple incoming data formats.

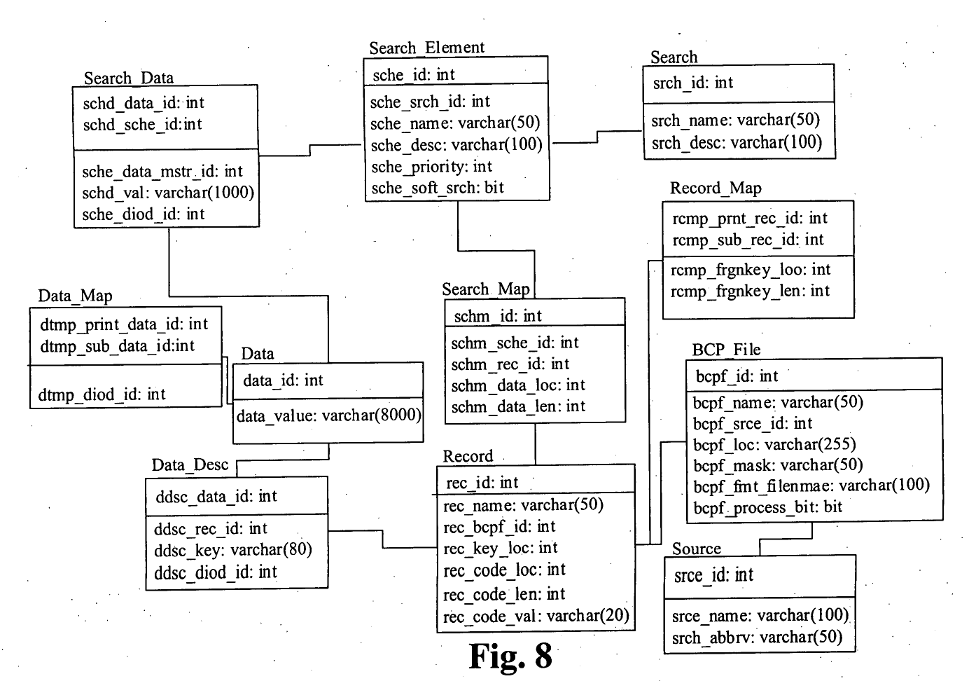

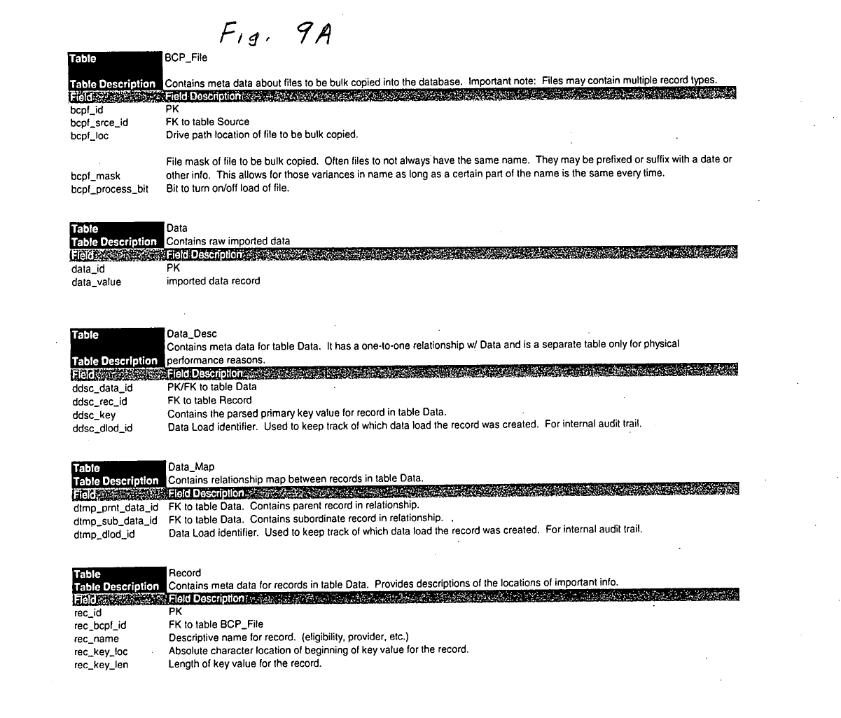

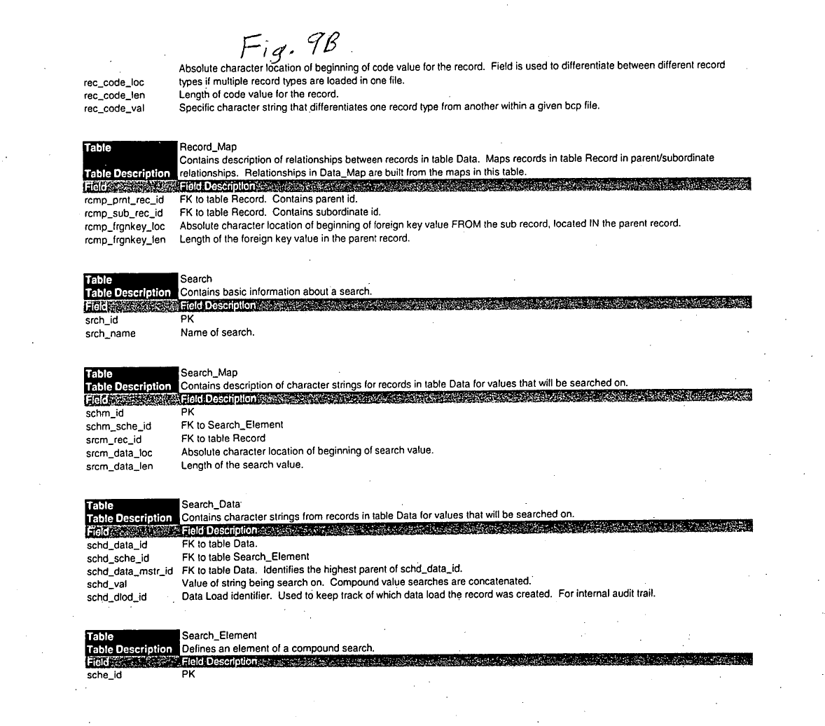

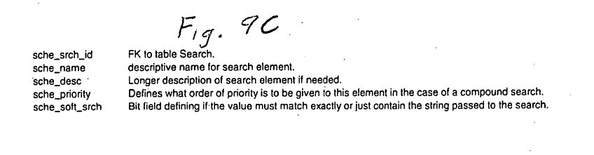

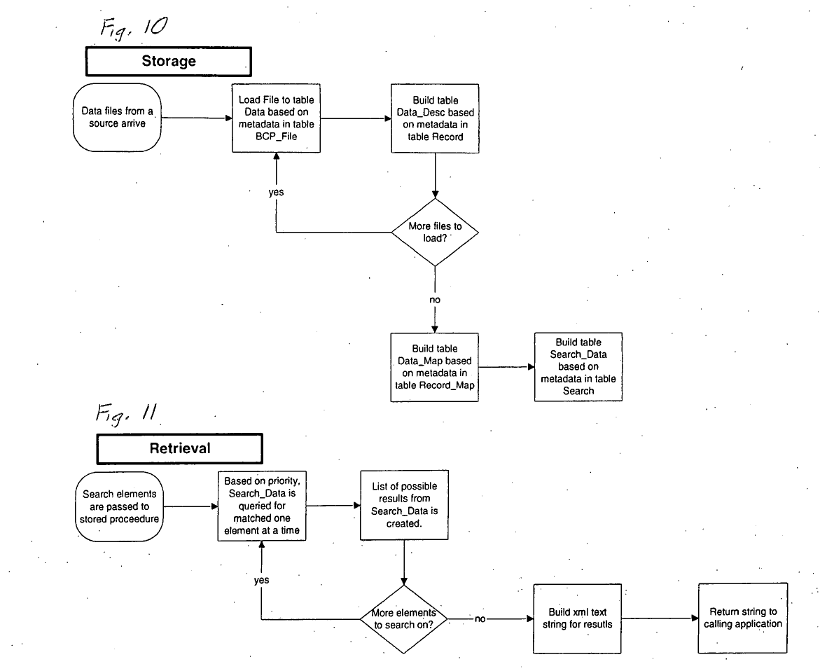

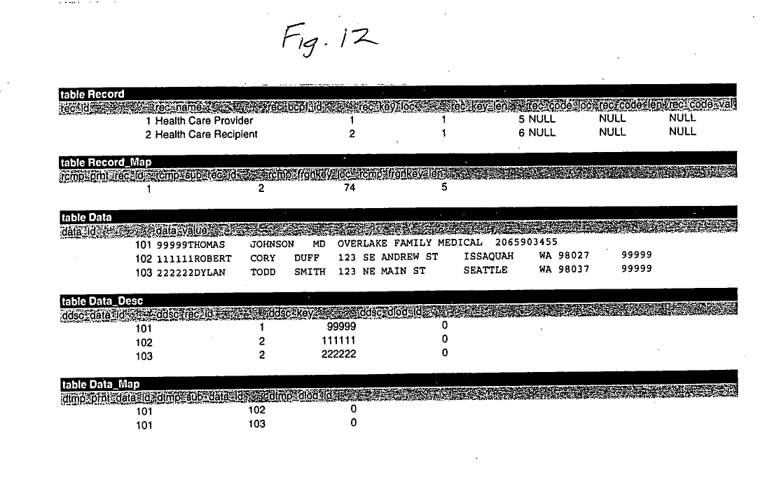

FIG. 8 is a schema of an exemplary embodiment of a data repository and/or database system. FIG. 9 is a description of fields of various tables of the schema of FIG. 8. FIG. 10 is a flow diagram of an exemplary embodiment of a storage procedure related to the schema of FIG. 8. FIG. 11 is a flow diagram of an exemplary embodiment of a retrieval procedure related to the schema of FIG. 8.

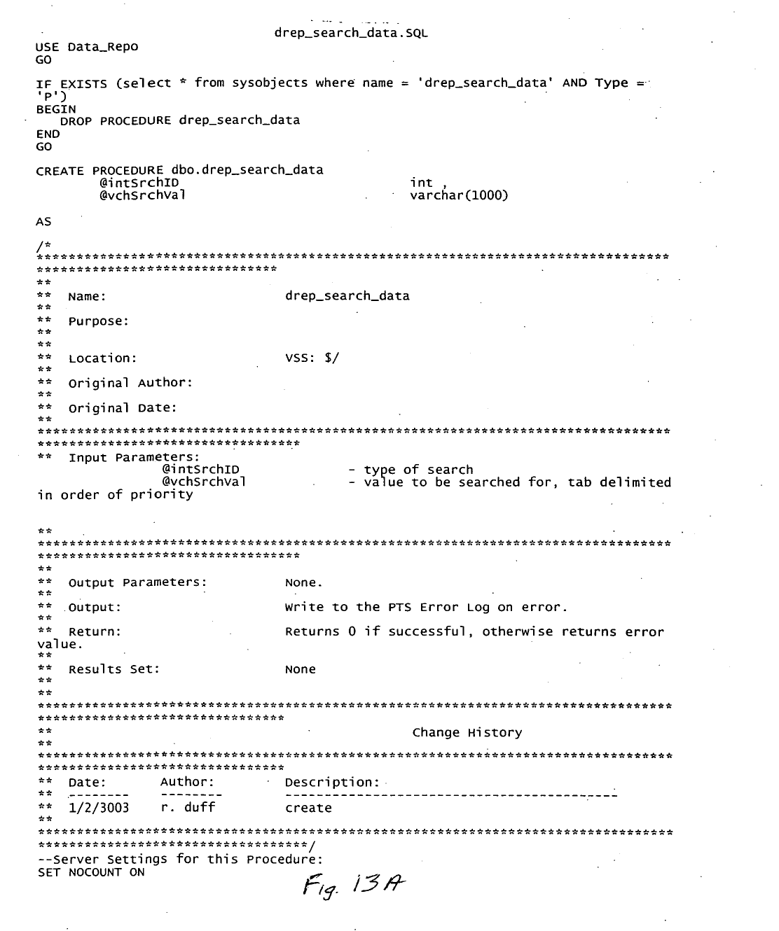

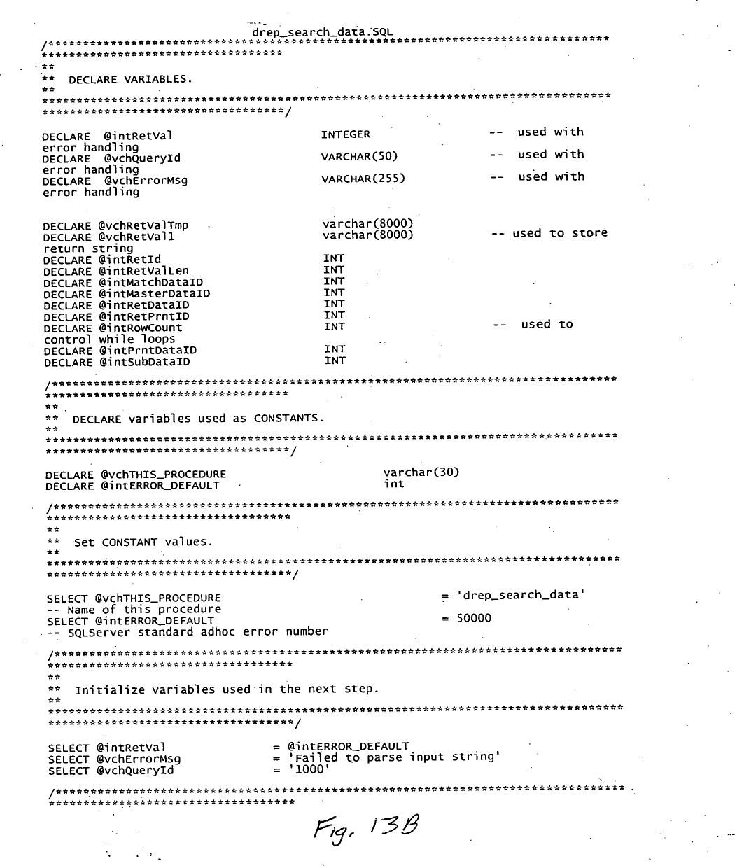

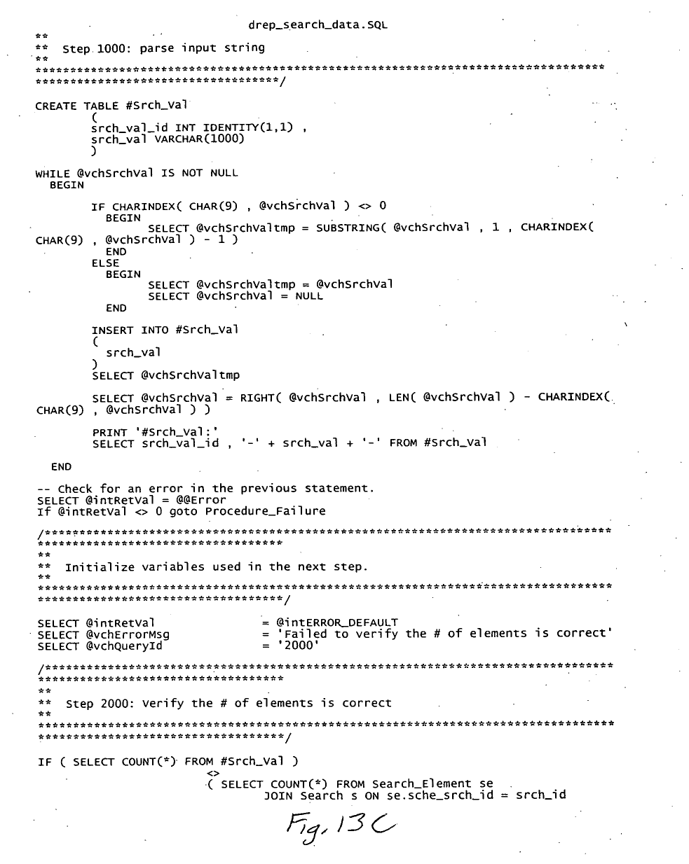

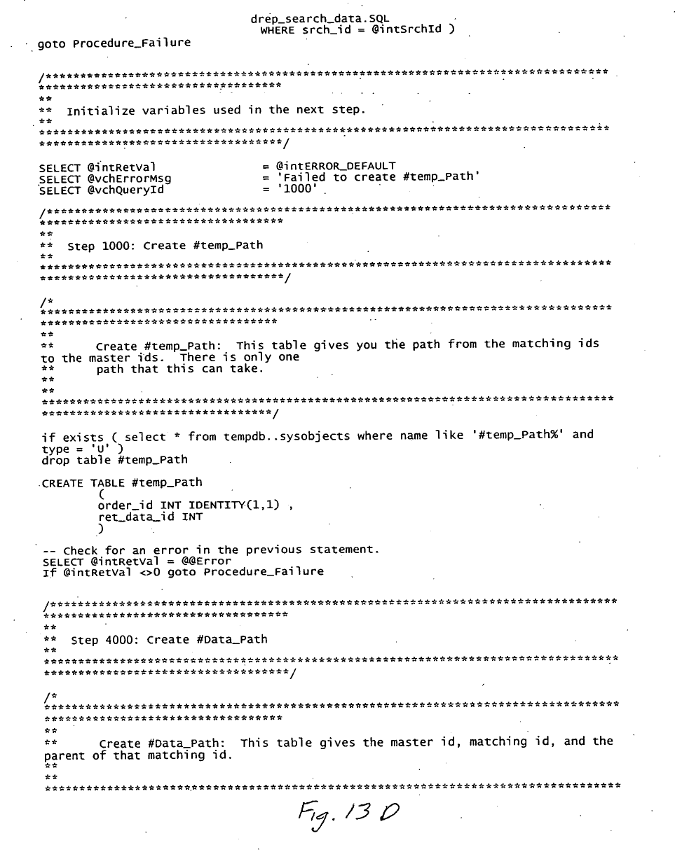

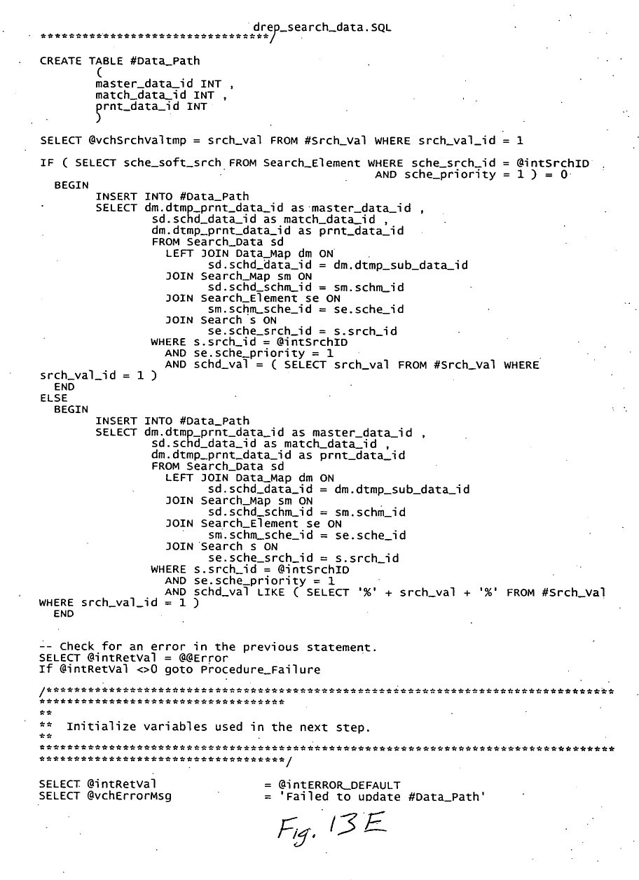

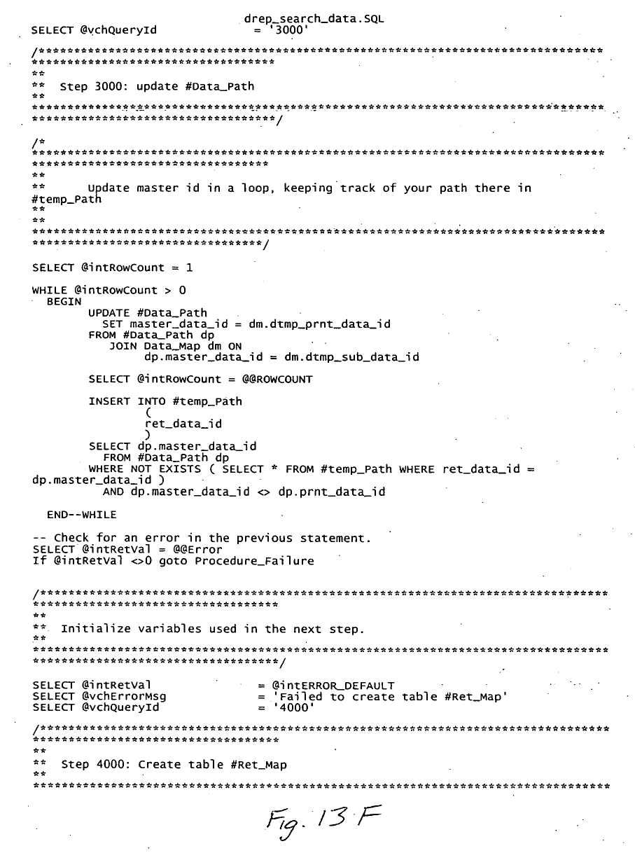

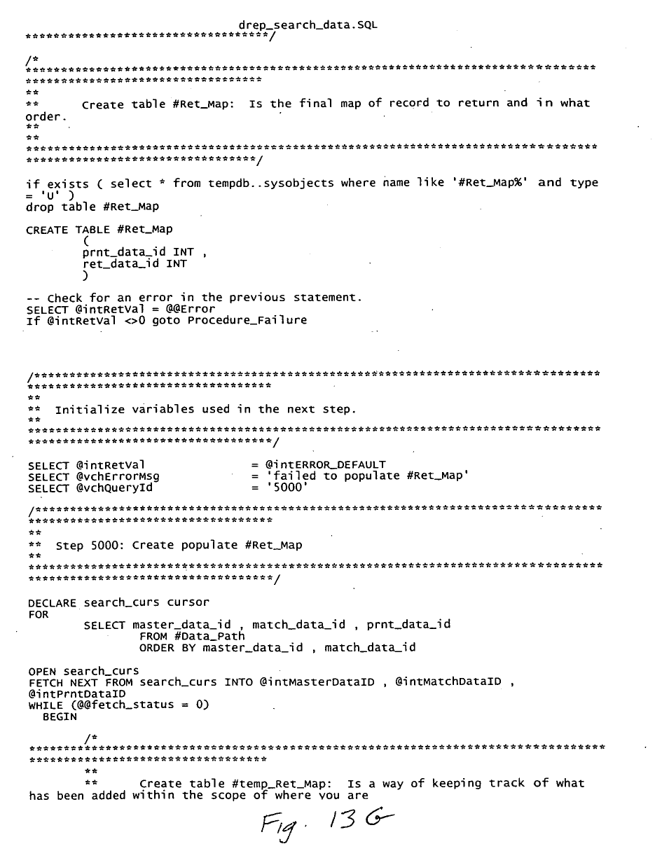

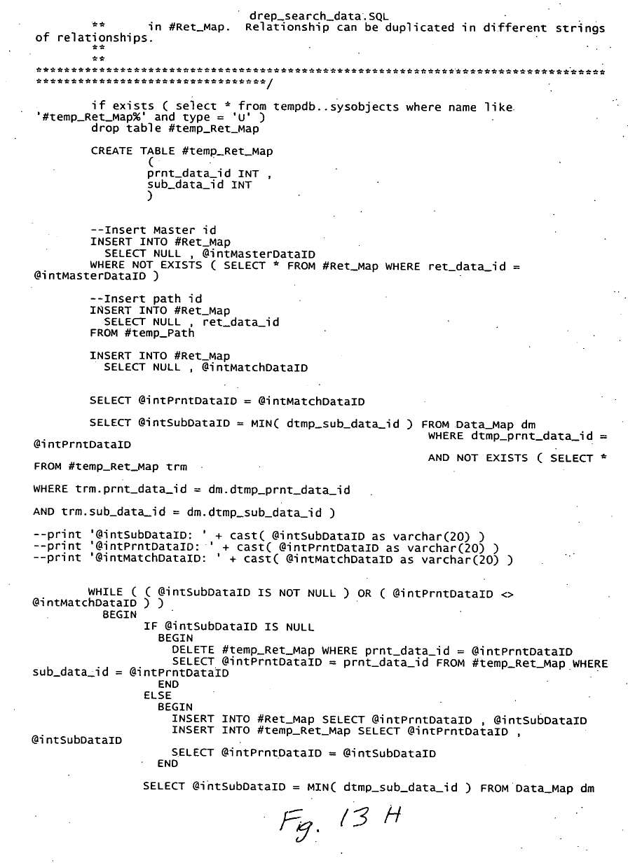

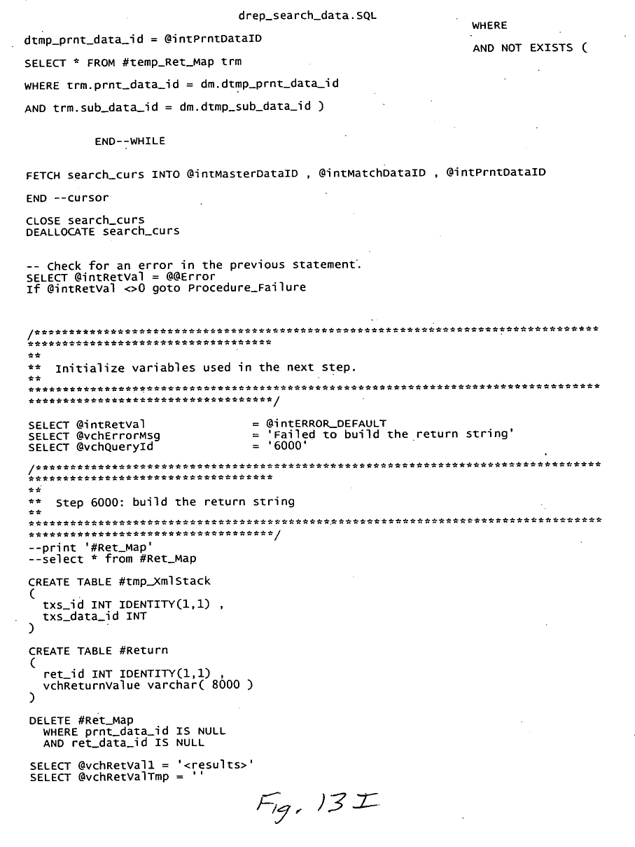

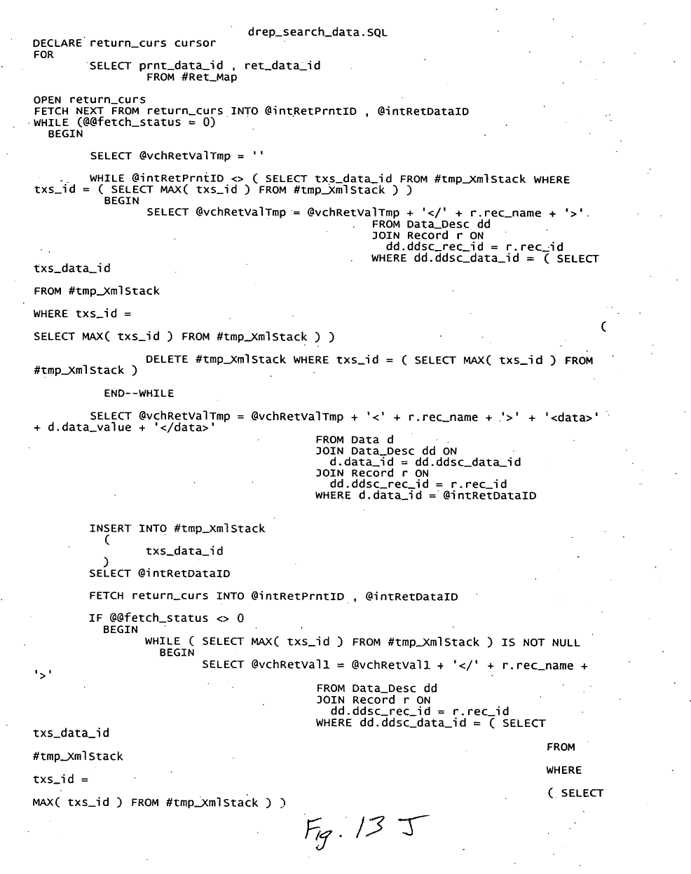

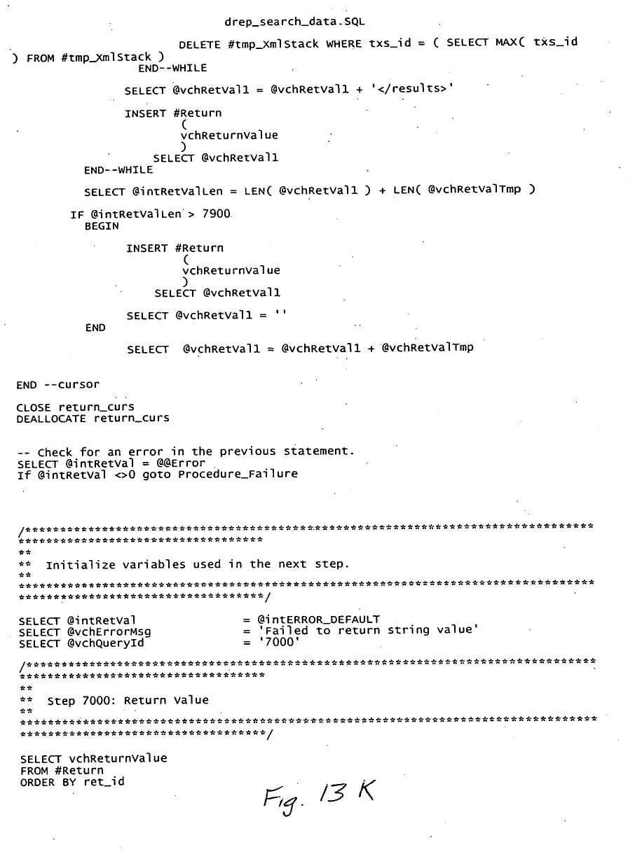

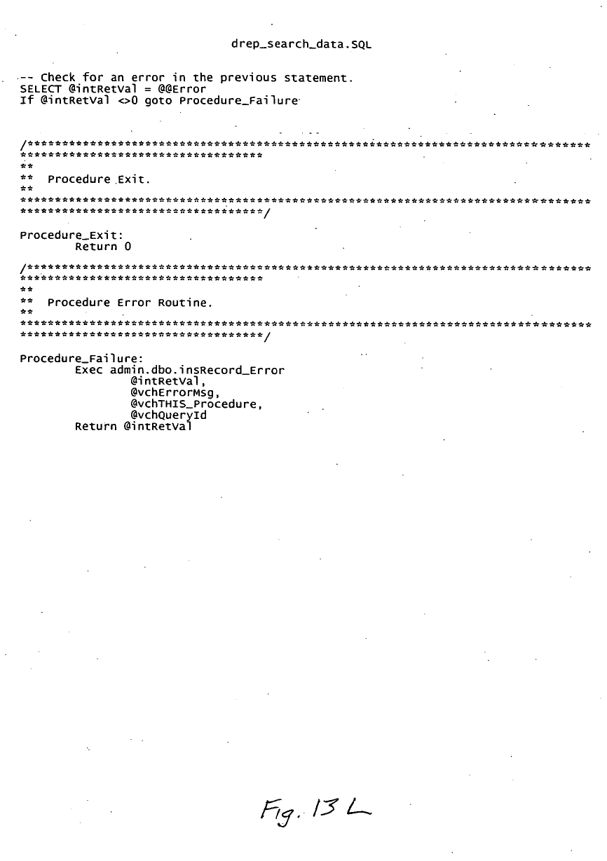

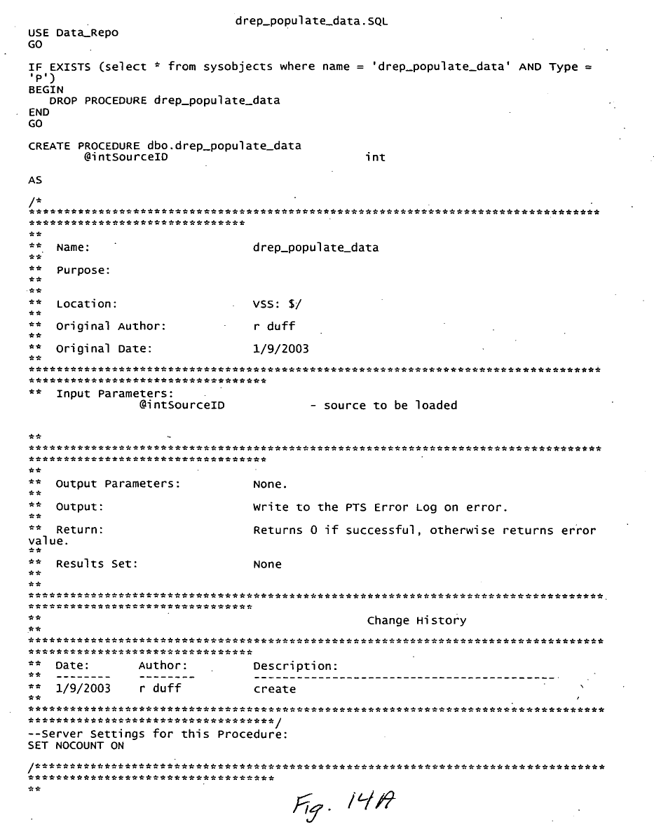

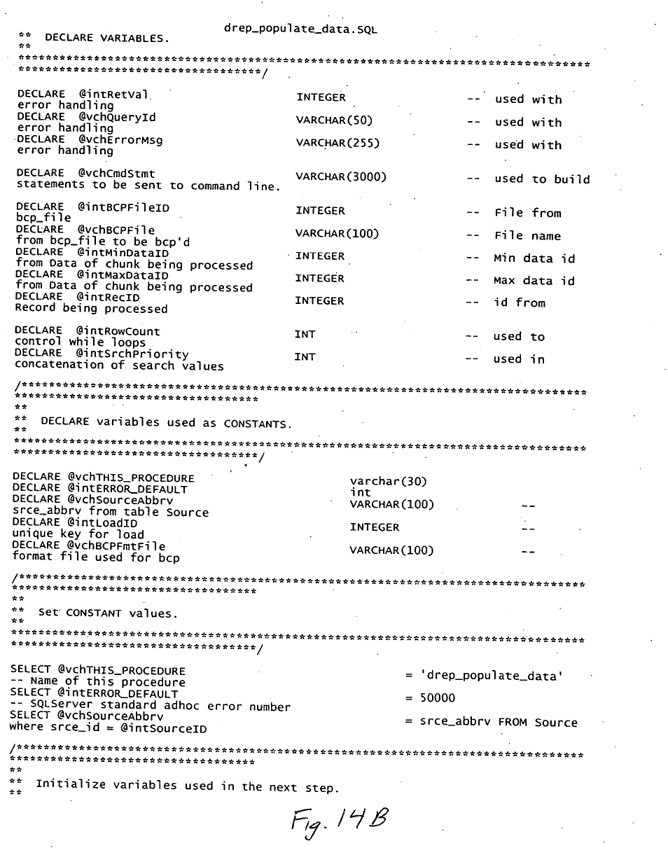

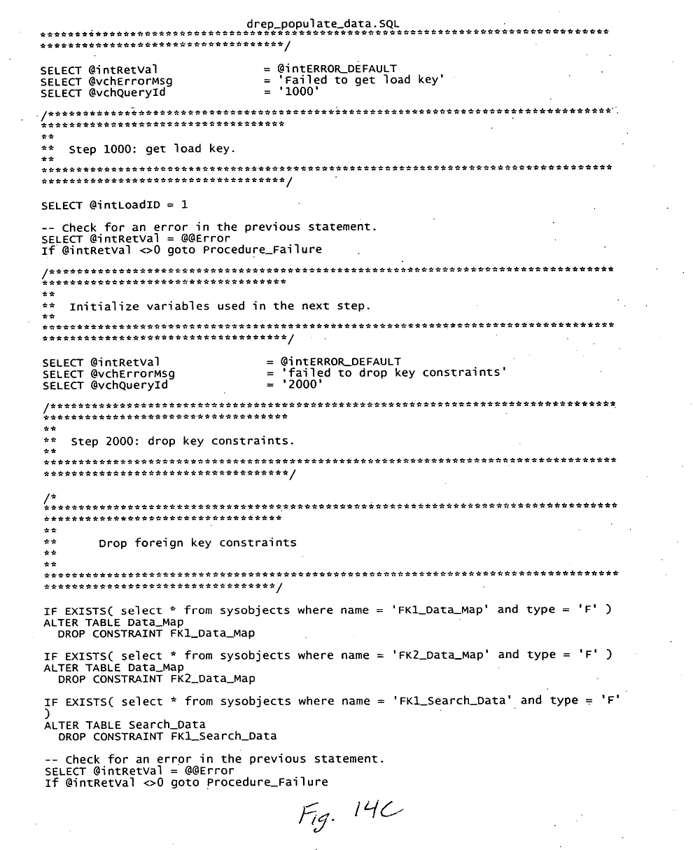

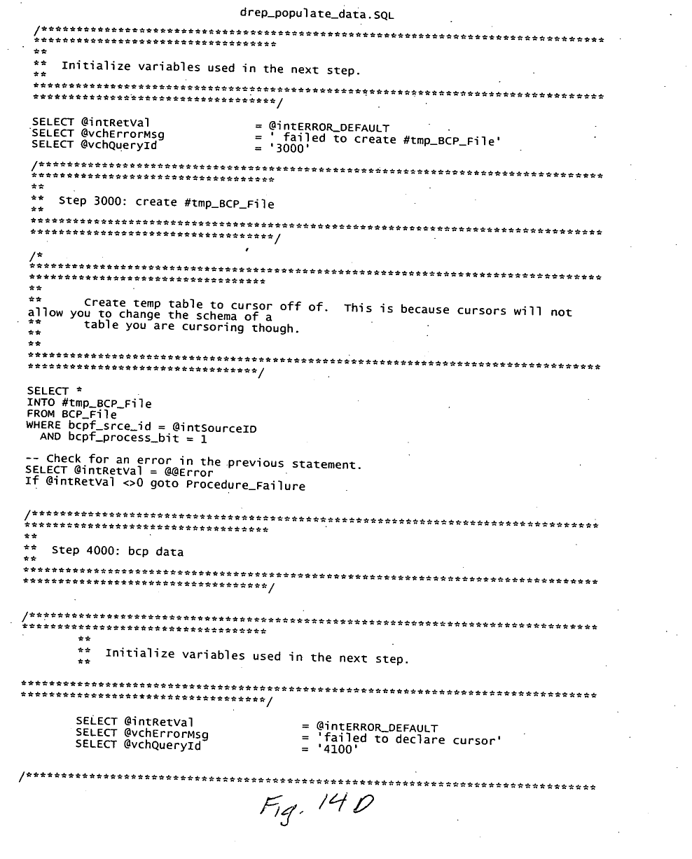

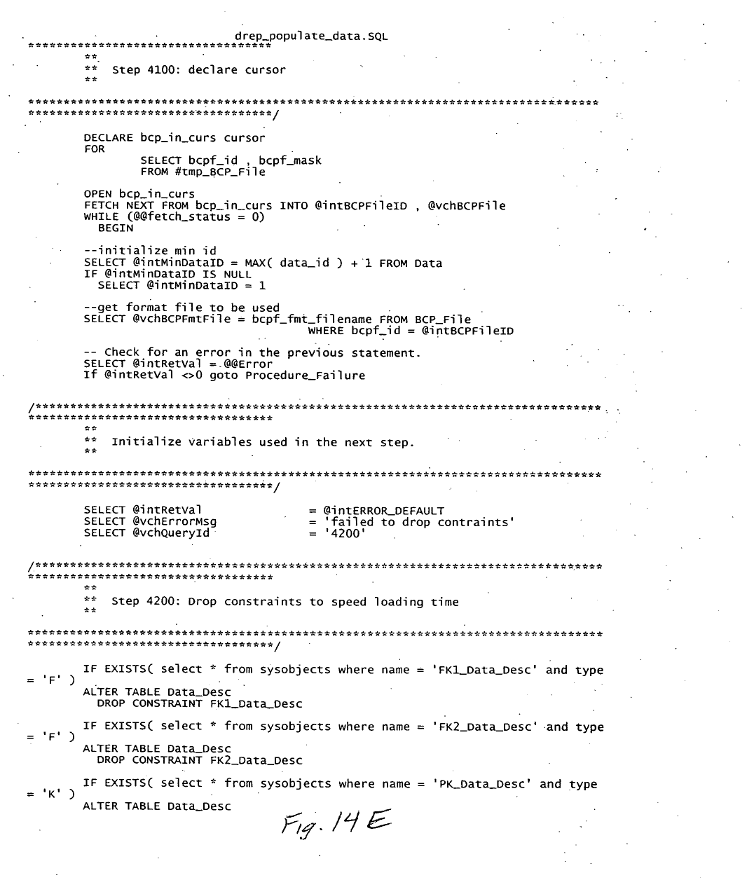

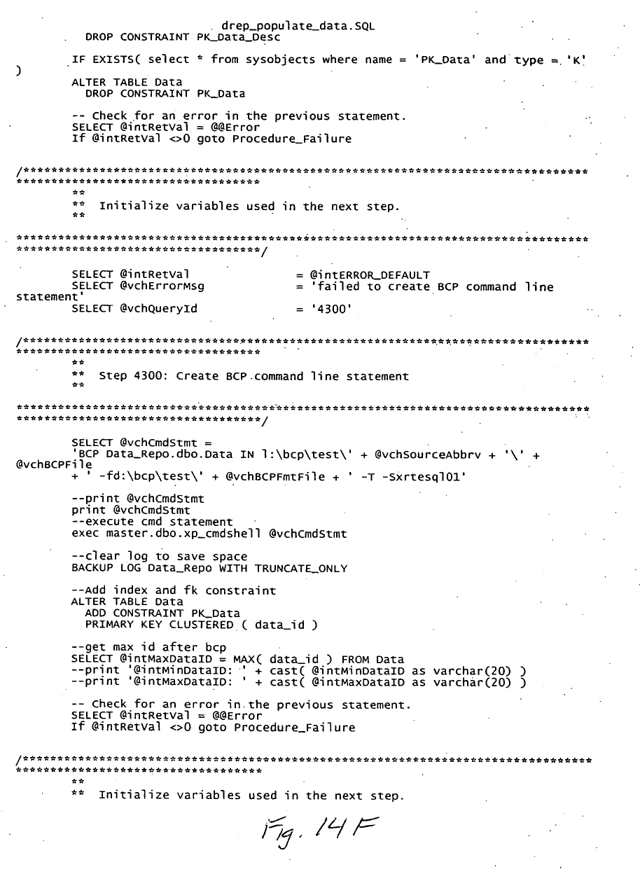

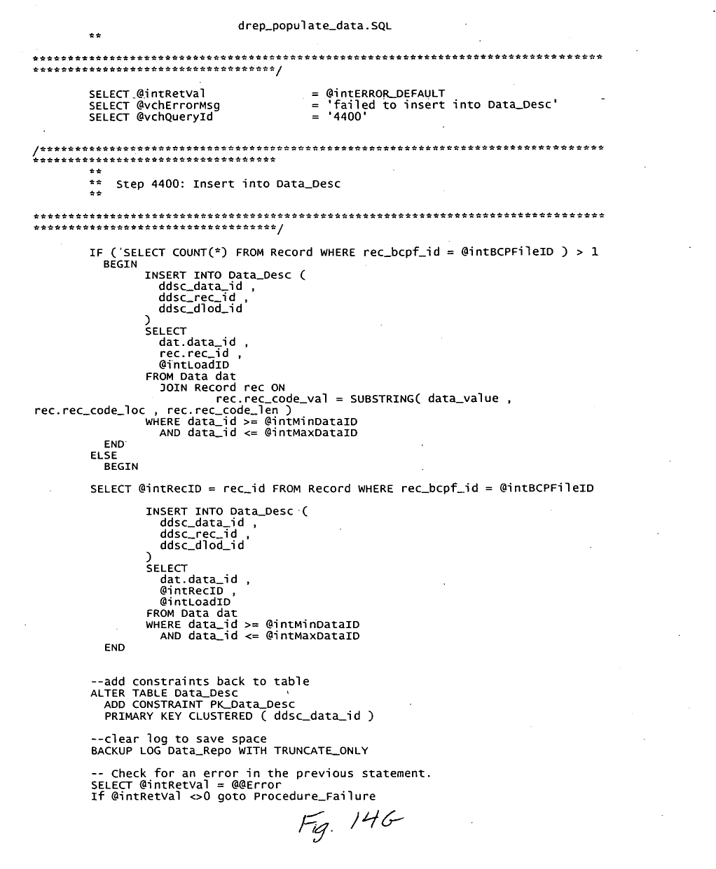

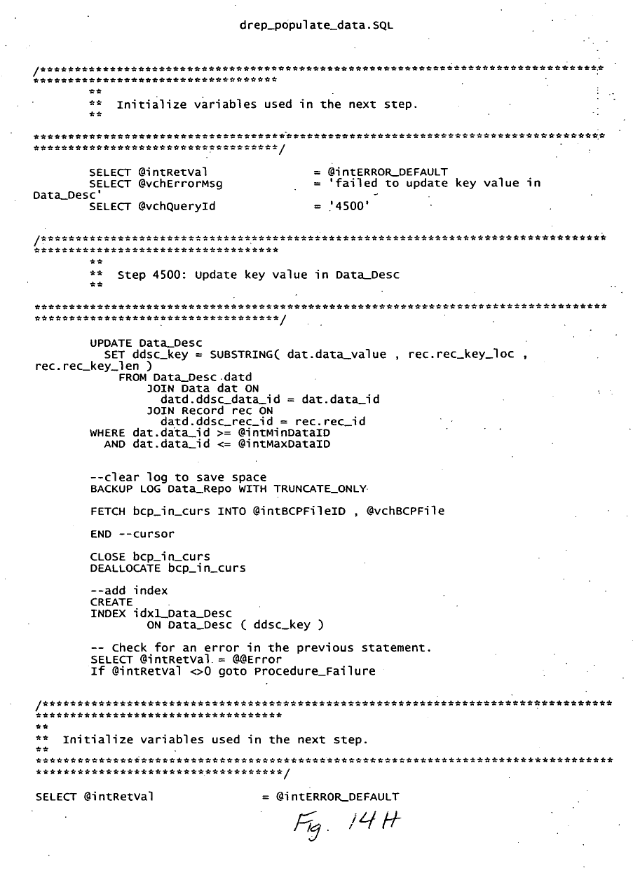

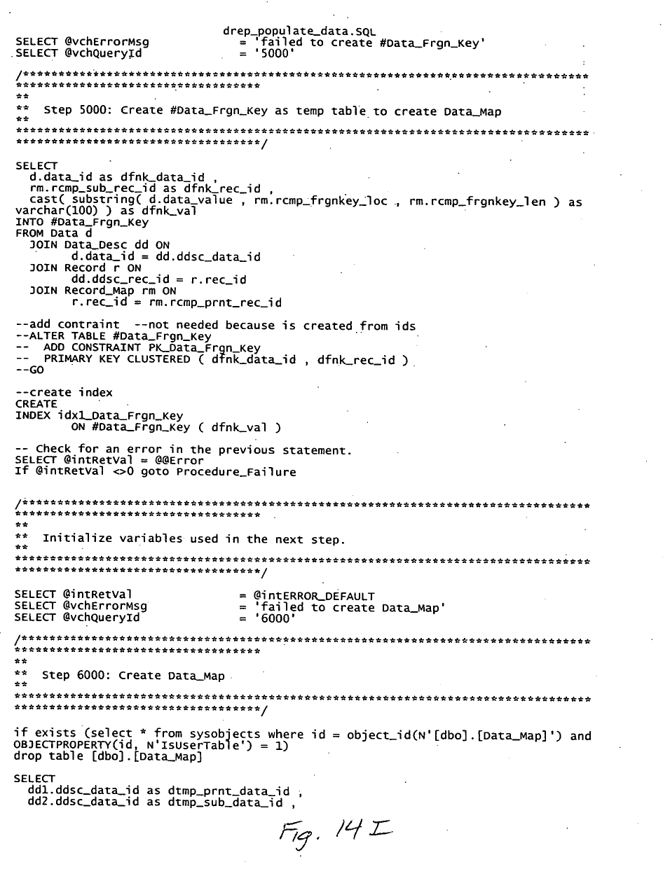

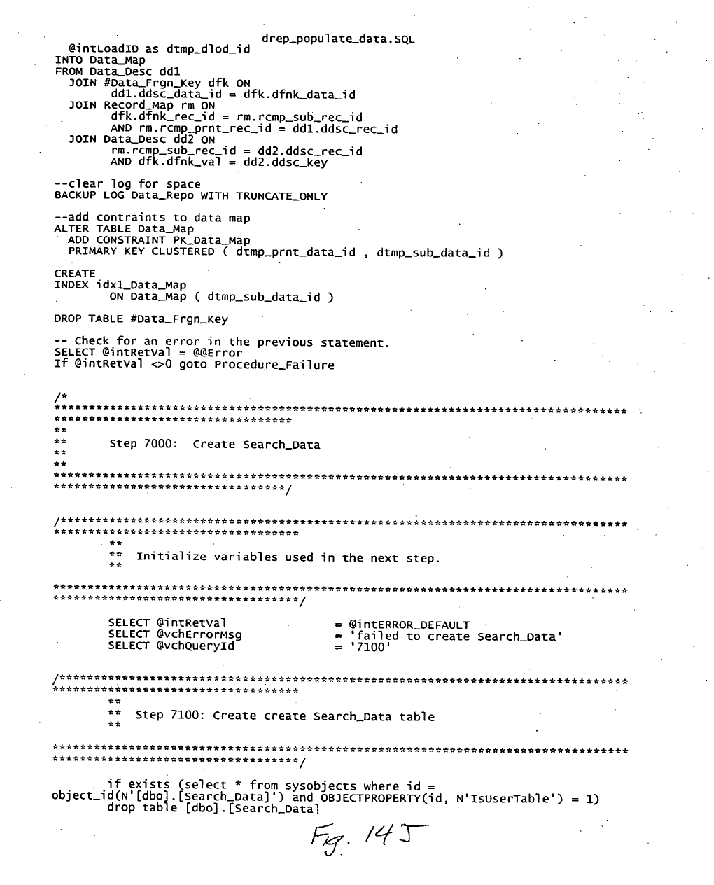

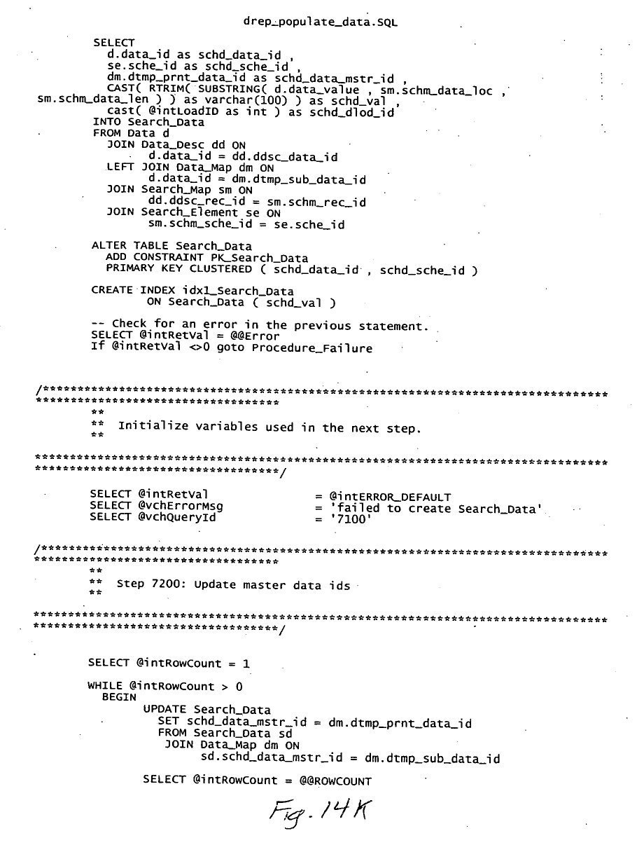

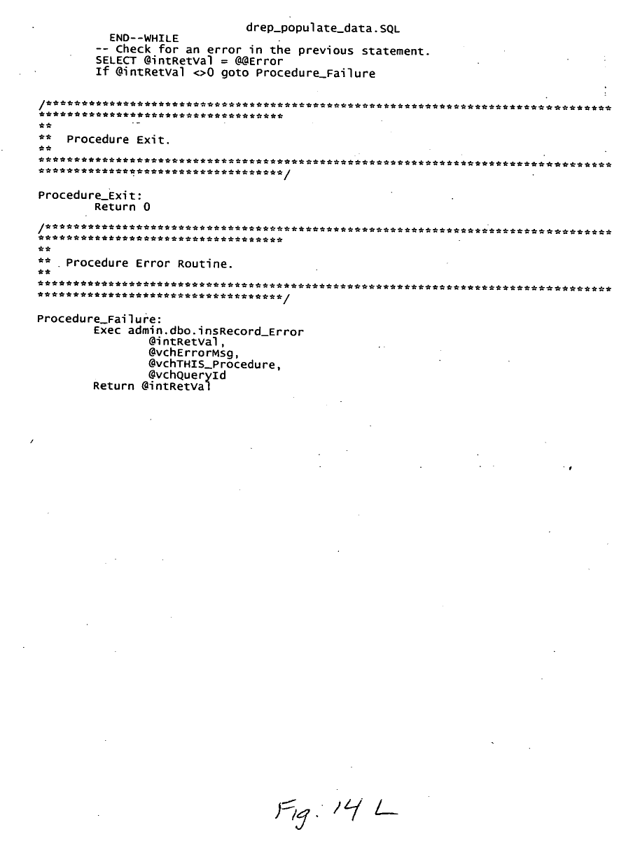

FIG. 12 is a list of exemplary data for the schema of FIG. 8. FIG. 13 is an exemplary embodiment of software code for implementing a data search procedure related to the schema of FIG. 8. FIG. 14 is an exemplary embodiment of software code for implementing a data population procedure related to the schema of FIG. 8.

In an exemplary embodiment of the schema described in FIG. 8, the process can begin with the arrival of remote data in the form of fixed length text files. The files are loaded one-by-one (in its entirety as a data string in one embodiment) into table Data, without additional processing. Table Data_Desc is populated with primary key information after the load of each file. The locations of the key information are stored in table Record, in the form of the location, and the length of the primary key.

Once the files are loaded and table Data_Desc is populated, populating table Data_Map creates relationships between records. For example, if you have a record with information about a person, and that record contains a foreign key to records about that person's dependents, this relationship is stored in Data_Map. The metadata describing these relationships is contained in table Record_Map. Record_Map describes which records have relationships, and where the foreign key is located to establish those relationships.

After all of the data is in place, table Search_Data is populated. Search_Map describes where an element to be searched on is located in a given record. This element is extracted and stored in Search_Data. During a search, only the elements stored in Search_Data are scanned. If a match is found, Search_Data points back to the original data in table Data.

In certain exemplary embodiments, the system can achieve superior performance by limiting processing to primarily the data that is retrieved by the system. Instead of parsing and mapping the data upon load, the parsing and mapping occurs as the data is pulled from the database. The system is usable to process any remote data not just healthcare related data. The system efficiently stores large amounts of data from multiple sources. It may be implemented as a central warehouse, or as a modularized system of storage areas, or any compromise of the two.

In certain exemplary embodiments, a record structure indicating Primary key and Foreign key record structure indication can be as follows:

1) Parent record(Heath care provider):

| Primary | |
|---|---|
| Key | Record |
| 99999 | THOMAS JOHNSON MD OVERLAKE FAMILY MEDICAL |
| | 2065903455 |

2) Child records(Health care recipients);

| Primary | | Foreign |
|---|---|---|
| Key | Record Body | Key |
| 111111 | ROBERT CORY DUFF 123 SE ANDREW ST | 99999 |
| | ISSAQUAH WA 98027 | |
| 222222 | DYLAN TODD SMITH 123 NE MAIN ST | 99999 |
| | SEATTLE WA 98037 | |

From this it can be established that both recipient records are children of the given provider record. The provider's primary key (99999) is embedded within the recipient records as a foreign key.

In table Record_Map, “FK to table record” means the field is a foreign key to table record. It contains the value of a primary key located in table record. With both parent and subordinate values, a parent/child relationship is established between two records in table data.

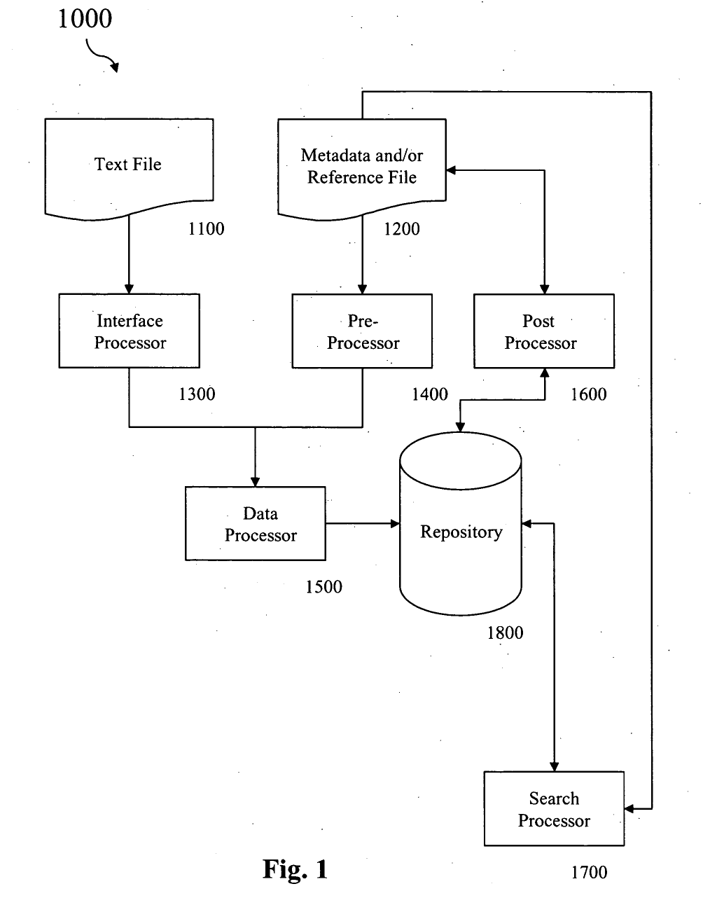

FIG. 1 is a block diagram of an exemplary embodiment of a system 1000. An interface processor 1300 is adapted to read a text file 1100 comprising a plurality of records containing data in a character string representative data format. Interface processor 1300 obtains text file 1100 from an information device and/or a repository. Text file 1100 is transmitted over a network.

A pre-processor 1400 either, parses metadata and/or a reference file 1200 to determine information necessary to convert text file 1100 to a composite database file, or searches for database information in text file 1100.

A data processor 1500 routes text file 1100 and/or reference file 1200 to a repository 1800 and/or otherwise acts as a processor. Data processor 1500 routes the reference file 1200 to repository 1800.

A post processor 1600 analyzes a record stored as a character string. The character string is taken from text file 1100. Post processor 1600 determines characteristics of the data such as the number of fields, the size of fields, and any key relationships present as fields in the character string. Post processor 1600 obtains information from reference file 1200 to characterize the structure of the character string. Post processor 1600 assigns a new key value to character strings read from text file 1100.

Search processor 1700 analyzes at least a portion of a database record stored as a character string in text file 1100. A search processor determines a master field and/or key information used for searching a database. The master field comprises a searched field contained in the character string. Search processor 1700 facilitates finding information contained in the character strings stored in repository 1800. Search processor 1700 obtains information about the character strings from reference file 1200.

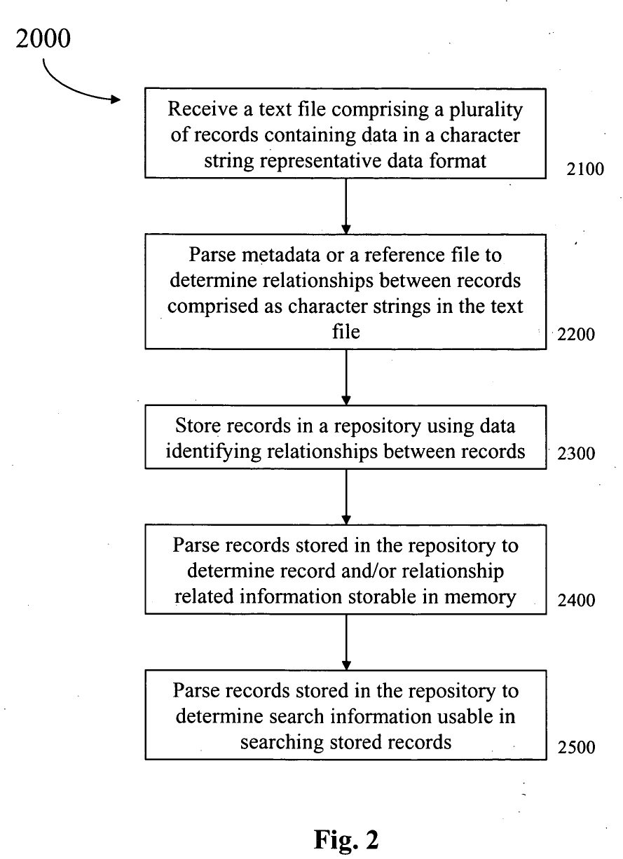

FIG. 2 is a flow diagram of an exemplary embodiment of a method 2000 for processing a text file. The text file comprises records from an original database. The records are written to the text file as character strings. The character strings are stored in the text file in a character string representative data format. In certain exemplary embodiments, the “character string representative data format” is ASCII (American Standard Code for Information Interchange). In other exemplary embodiments, the character string representative data format is, for example, extended ASCII, Rich Text Format, Microsoft Word, Word Perfect, HTML, and/or XML, etc. An individual record, of a plurality of records comprised in the text file, includes an identifier for identifying a specific individual record from the plurality of records.

At activity 2100, an interface processor receives the text file. The text file is received from an information device, repository, and/or a network, etc. The text file comprises a plurality of records containing data in a character string representative data format.

At activity 2200, metadata and/or a reference file related to the text file are parsed by a pre-processor. The pre-processor determines relationships between records comprised as character strings in the text file. The relationships between records comprise a key relationship. The pre-processor stores data identifying the relationships in a repository. The data identifying the relationships are used for parsing the character strings and/or locating information embedded in the character strings from the text file.

In certain exemplary embodiments, the data identifying relationships comprises a tabular structure having both data rows and columns, a plurality of tabular structures, a mapping structure, and/or adjacent memory locations, etc.

In certain exemplary embodiments, the data identifying relationships further comprises a plurality of data elements associated with relationships between records and comprises one or more of the following: an identifier for identifying a specific data element from the plurality of data elements, an identifier for identifying a specific data element of a plurality of data elements associated with a storage file comprised in the text file, a descriptive name for a record, a location in a record of an identifier for identifying a specific record, a length in number of characters of an identifier for identifying a specific record, a location in a record for a code for identifying a record type, a length in number of characters of the code for identifying a record type, and/or a character string used to differentiate record types, etc.

In certain exemplary embodiments, the data identifying relationships further comprises one or more of the following: an identifier identifying a specific data element of the plurality of data elements that is associated with a parent record of the plurality of records, an identifier identifying a specific data element of the plurality of data elements that is associated with a child record of the plurality of records, an identifier indicating in a child record the start of an identifier for identifying a parent record, and/or a length of an identifier, in a child record, for identifying a parent record, etc. Data identifying relationships represents primary keys, foreign keys, and structural information related to records. In certain exemplary embodiments, data identifying relationships allows a user to find information contained within the text file. In other embodiments, data identifying relationships allows a user to organize and/or process information contained in the text file.

The pre-processor assigns a value to an identifier for identifying the specific data element of the plurality of data elements irrespective of the value of the identifier for identifying the specific individual record. The identifier for identifying the specific data element of the plurality of data elements represents a new primary key value assigned from the pre-processor. Assigning the identifier for identifying the specific data element enhances the searchability of the plurality of data elements stored as character strings.

At activity 2300, a data processor stores records in a repository. The data processor stores the records as character strings. The records are obtained from the text file and are stored using data identifying relationships between the records. The data identifying relationships between records are determined by parsing metadata and/or the reference file. The data processor is adapted to store the records comprised in the text file in the repository using the data identifying the relationships, without parsing the records, during storage of the records. Storing the data as character strings reduces demands on the data processor as compared to parsing each record into defined fields and filling the fields with parsed data.

The data processor assigns new identifier values to uniquely identify individual records of the plurality of records. The data processor incorporates the new identifier values in corresponding individual records of the plurality of records and stores the records in the repository. The new identifier values are separate and distinct from record identifier values contained within the records as received by the interface processor. The new identifier values represent new primary key values used for locating records and information responsive to a user query.

At activity 2400, a post processor parses records stored in the repository. The post processor determines record and/or relationship related information from parsing the records. Parsing by the post processor comprises locating a key relationship within a record. The record and/or relationship information is stored in a repository. The record and/or relationship information, in certain operative embodiments, comprises: assigned new identifier values, an identifier for identifying a specific data element of a plurality of data elements associated with a record relationship, identifiers for identifying individual records, an indicator identifying a particular data load operation from a plurality of different load operations used to store the records in the repository, an assigned new identifier value associated with a parent record, and/or an assigned new identifier value associated with a child record of the parent record. Parsing records makes information contained in the character strings locatable and usable.

At activity 2500, a search processor parses records stored in the repository. The post processor determines search information from parsing the records. The search information is used in parsing stored records for data. The search information comprises data elements available to be searched, linking information identifying corresponding stored records containing the identified data elements, and corresponding locations of the data elements available for searching in the corresponding stored records.

The search processor provides a response to the identification of a data element. In certain exemplary embodiments, the data element is determined by search criteria found in the search information. The search processor provides data identifying a record including the data element determined by the search criteria.

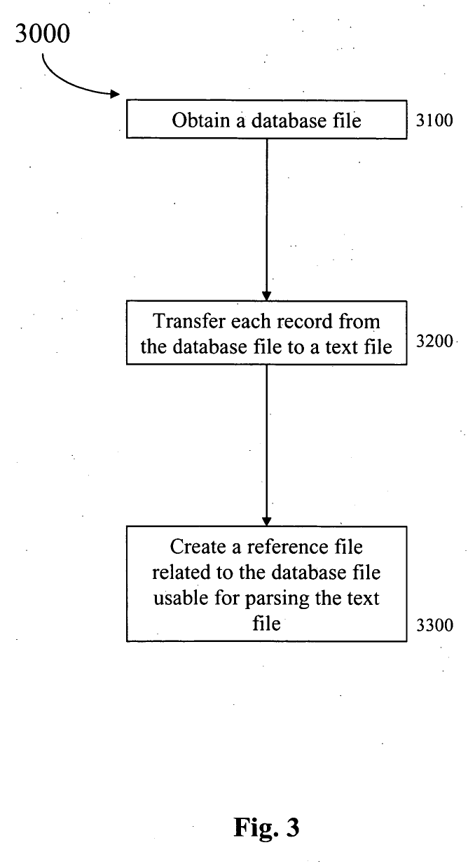

FIG. 3 is a flow diagram of an exemplary embodiment of a method of use 3000 for converting a database file to a text file. At activity 3100, a database file is obtained. A database file employs a particular schema. A database file is created using any database standard.

At activity 3200, records are transferred from the database file to a text file. Each record is transferred from the database file to the text file as a single character string. In alternative embodiments, each record is transferred from the database file to the text file as a plurality of character strings. In certain exemplary embodiments, the transferring activity takes place automatically. In other exemplary embodiments, the transferring activity takes place responsive to a user input.

At activity 3300, metadata and/or a reference file are created and are related to the database file. The reference file comprises metadata about the database and/or the database schema. Metadata and/or the reference file comprise a key relationship. The metadata and/or reference file are used in parsing a text file created from the database file or generating a composite database file and a composite database structure file.

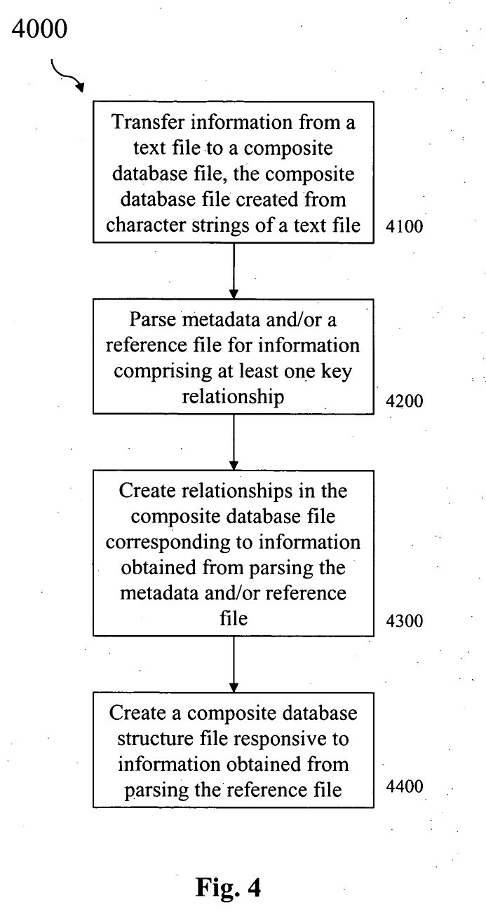

FIG. 4 is a flow diagram of an exemplary embodiment of a method of use 4000 for converting a text file to a composite database file. At activity 4100, information is transferred from a text file to a composite database file. The composite database file comprises character strings from a single text file created from a single database standard. In other embodiments, the composite database file comprises character strings from a plurality of text files created from a plurality of database standards.

At activity 4200, metadata and/or a reference file related to the text file is parsed to determine information comprising at least one key relationship. Information in the reference file further comprises one or more of the following: a primary key, a foreign key, a table size, a table structure, a record size, a number of records, a record count, a record name, a record format, a field size, a field name, and/or a field format, etc.

At activity 4300, relationships are created in the composite database file corresponding to information obtained from parsing metadata and/or the reference file. Relationships comprise primary key relationships and/or foreign key relationships, etc.

At activity 4400, a composite database structure file is created responsive to information obtained from parsing metadata and/or the reference file. The database structure file effectively represents a schema for the composite database file. The database structure file comprises information from a plurality of metadata and/or reference files related to a plurality of text files. The database structure file is used to search for information in the composite database file.

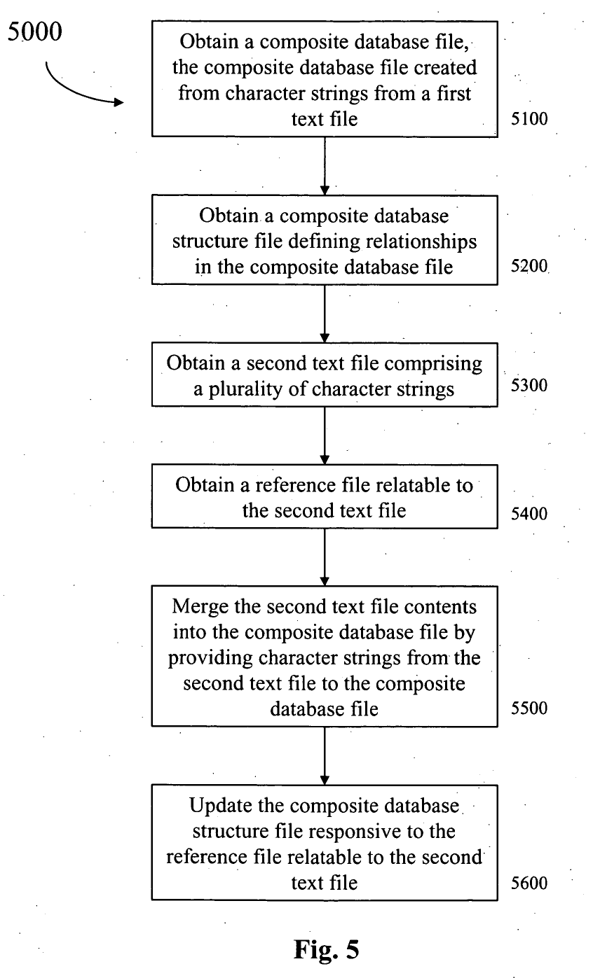

FIG. 5 is a flow diagram of an exemplary embodiment of a method of use 5000 for updating a composite database file. At activity 5100, a composite database file is obtained. The composite database file is created from a first text file. The first text file is related to a first original database. The composite database has a related composite database structure file.

At activity 5200, the composite database structure file related to the composite database file is obtained.

At activity 5300, a second text file is obtained comprising a plurality of character strings. In certain exemplary embodiments, the second text file is related to a second original database file.

At activity 5400, metadata and/or a reference file related to the second text file are obtained. Metadata and/or the reference file comprise at least one key relationship.

At activity 5500, the contents of the second text file are merged into the composite database file. Character strings from the second text file are provided to the composite database file.

At activity 5600, the composite database structure file is updated responsive to the reference file related to the second text file. Merging the second text file with the composite database file provides functionality to update the composite database file responsive to changes occurring over time. Additionally, merging the second text file with the composite database file allows a plurality of databases from a plurality of sources to be included in the composite database file. This functionality allows a user to effectively parse a plurality of databases from a plurality of sources with a single query from a single composite database file.

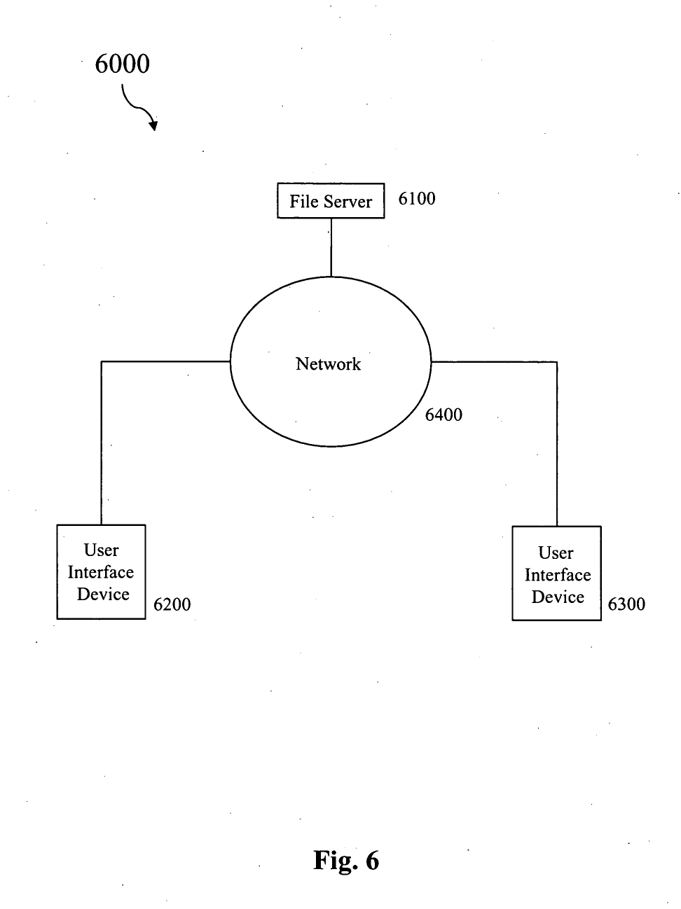

FIG. 6 is a block diagram of an exemplary embodiment of a system 6000. As illustrated, system 6000 comprises at least one file server 6100, which is an information device. File server 6100 provides continuous processing, batch processing, and/or storage of large quantities of information. File server 6100 acts as a server in a client-server relationship with user interface device 6200, 6300. In certain operative embodiments, file server 6100 hosts a database, such as repository 1800 of system 1000 of FIG. 1.

User interface device 6200, 6300, which is an information device, and upon which at least a portion of at least one method, such as activity 2100 of method 2000 of FIG. 2, allows users to communicate and/or interact with file server 6100 and/or other user interface devices. As used herein “interact” means receiving alerts or notifications, providing user input, reviewing data, revising, or switching programs, examining processing algorithms, and/or modifying graphics displays, etc.

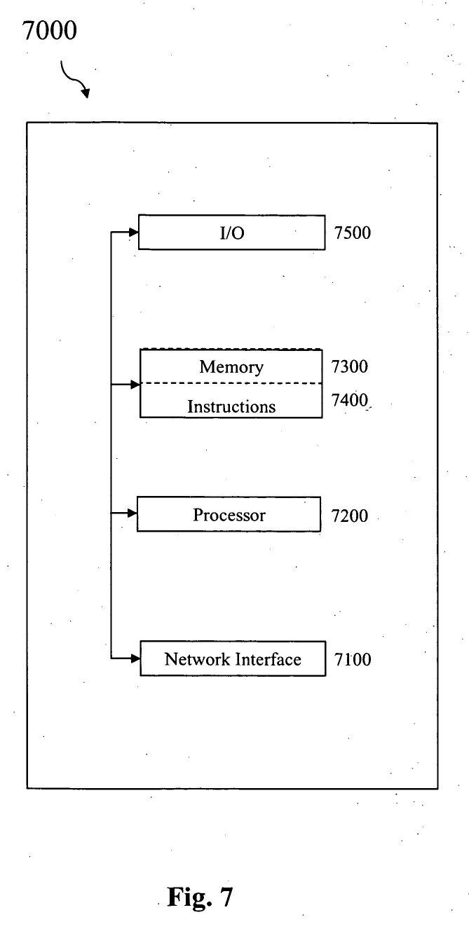

In certain exemplary embodiments, file server 6100 is coupled to a user interface device 6200, 6300 via a network 6400. In certain exemplary embodiments, network 6400 is a public, private, circuit-switched, packet-switched, virtual, radio, telephone, cellular, cable, DSL, satellite, microwave, AC power, twisted pair, ethernet, token ring, LAN, WAN, Internet, intranet, wireless, Wi-Fi, BlueTooth, Airport, 802.11a, 802.11b, 802.11g, and/or any equivalents thereof, etc., network. FIG. 7 is a block diagram of an exemplary embodiment of an information device 7000, which in certain operative embodiments represents file server 6100 and/or user interface device 6200, 6300 of FIG. 6. Information device 7000 includes well-known components such as one or more network interfaces 7100, one or more processors 7200, one or more memories 7300 containing instructions 7400 and/or data, and/or one or more input/output (I/O) devices 7500, etc.

Still other embodiments will become readily apparent to those skilled in this art from reading the above-recited detailed description and drawings of certain exemplary embodiments.

What is claimed is:

1. A system for storing information in a repository (1800), comprising:
an interface processor (1300) for receiving a text file (1100) comprising a plurality of records containing data in a character string representative data format;
a pre-processor (1400) for parsing a reference file (1200) to determine relationships between records comprised as character strings in said text file (1100), said relationships comprising a key relationship, and for storing data identifying said relationships in memory; and
a data processor (1500) for storing said records comprised as character strings in said text file (1100) in a repository (1800) using said data identifying said relationships.

2. A system according to claim 1, wherein
the reference file (1200) comprises metadata (1200).

3. A system according to claim 1, wherein
said character string representative data format comprises at least one of,
(a) ASCII (American Standard Code for Information Interchange) format and
(b) another character representative data format.

4. A system according to claim 1, wherein
said pre-processor (1400) is adapted to store said data identifying said relationships in an organized data structure in said memory comprising at least one of, (a) a tabular structure having both data rows and columns, (b) a plurality of tabular structures, (c) a mapping structure and (d) adjacent memory locations.

5. A system according to claim 1, wherein
said data identifying said relationships comprises a plurality of data elements associated with a record relationship and include at least one of, (a) an identifier for identifying a specific data element of said plurality of data elements, (b) an identifier for identifying a specific data element of a plurality of data elements associated with a storage file comprised in said text file (1100), (c) a descriptive name for a record, (d) a location in a record for start of an identifier for identifying a specific record, (e) a length in number of characters of an identifier for identifying a specific record.

6. A system according to claim 5, wherein
said data identifying said relationships comprises a plurality of data elements associated with a record relationship and include at least one of, (i) a location in a record for start of a code for identifying a record type, (ii) a length in number of characters of said code for identifying a record type and (iii) a character string used to differentiate record types.

7. A system according to claim 5, wherein
an individual record of said plurality of records comprised in said text file (1100) includes an identifier for identifying a specific individual record of said plurality of records and
said pre-processor (1400) is adapted to assign a value for said identifier for identifying said specific data element of said plurality of data elements irrespectively of a value of said identifier for identifying said specific individual record.

8. A system according to claim 5, wherein
said data identifying said relationships comprises a subset of information determining at least one of, (a) an identifier identifying a specific data element of said plurality of data elements is associated with a parent record of said plurality of records, (b) an identifier identifying a specific data element of said plurality of data elements is associated with a child record of said plurality of records, (c) a location in a child record for the start of an identifier for identifying a parent record, and (d) a length of an identifier, for identifying a parent record, and conveyed in a child record.

9. A system according to claim 1, wherein
said data processor (1500) is adapted to store said records comprised in said text file (1100) in said repository (1800) using said data identifying said relationships without parsing said records during storage of said records.

10. A system according to claim 1, wherein
said data processor (1500) is adapted to assign new identifier values to uniquely identify individual records of said plurality of records and incorporates said new identifier values in corresponding individual records of said plurality of records and stores said records in said repository (1800), said new identifier values being separate from record identifier values contained within said records received by said interface processor (1300).

11. A system according to claim 10, further comprising:
a post-processor (1600) for parsing said records stored in said repository (1800) to determine record related information and for storing said record related information in memory, said record related information comprising at least one of, (a) said assigned new identifier values, (b) an identifier for identifying a specific data element of a plurality of data elements associated with a record relationship, (c) identifiers for identifying individual records and (d) an indicator identifying a particular data load operation, from a plurality of different load operations, used to store said records in said repository (1800).

12. A system according to claim 10, further comprising:
a post-processor (1600) for parsing said records stored in said repository (1800) to determine information identifying relationships between said stored records and for storing said information identifying relationships in memory, said information identifying relationships comprising at least one of, (a) an assigned new identifier value associated with a parent record and (b) an assigned new identifier value associated with a child record of said parent record.

13. A system according to claim 10, further comprising:
a search processor (1700) for parsing said records stored in said repository (1800) to determine search information to be usable in searching said stored records and for storing said search information in memory.

14. A system according to claim 10, wherein
said search information is adapted to identify data elements available to be searched and linking information identifying corresponding stored records containing said identified data elements and corresponding locations of said data elements available for search in said corresponding stored records.

15. A system according to claim 14, wherein
in response to a received search command, said search processor (1700) is adapted to parse said stored search information and in response to identification of a data element, determined by search criteria, in said search information, said search processor (1700) provides data identifying a record including said data element determined by said search criteria.

16. A system according to claim 1, wherein
said data processor (1500) is adapted to store said records comprised in said text file (1100) in said repository (1800) as a data string.

17. A system for storing information in a repository (1800), comprising:
an interface processor (1300) for receiving a text file (1100) comprising a plurality of records containing data in character string representative data format;
a data processor (1500) for storing said records comprised in said text file (1100) in a repository (1800) using data identifying relationships, said data identifying relationships comprising at least one key relationship, between records comprised in said text file (1100); and
a search processor (1700) for parsing a reference file (1200) to determine search information to be used in searching said stored records and for storing said search information in memory.

18. A system according to claim 17, wherein
said search information identifies data elements available to be searched and linking information identifying corresponding stored records containing said identified data elements and corresponding locations of said data elements available for search in said corresponding stored records.

19. A system for storing information in a repository (1800), comprising:
an interface processor (1300) for receiving a text file (1100) comprising a plurality of records containing data in character string representative data format;
a data processor ( 1500) for:
assigning new identifier values to uniquely identify individual records of said plurality of records;
incorporating said new identifier values in corresponding individual records of said plurality of records to provide processed records; and
storing said processed records in a repository (1800), said assigned new identifier values being separate from record identifier values contained within said records received by said interface processor (1300); and
a post-processor (1600) for parsing said processed records stored in said repository (1800) to determine record related information and for storing said record related information in memory.

20. A system according to claim 19, wherein
said record related information comprising at least one of, (a) said assigned new identifier values, (b) an identifier for identifying a specific data element of a plurality of data elements associated with a record relationship, (c) identifiers for identifying individual records and (d) an indicator identifying a particular data load operation, from a plurality of different load operations, used to store said records in said repository (1800).

21. A system according to claim 19, wherein
said data processor (1500) stores said records comprised in said text file (1100) in a repository (1800) using data identifying relationships between records comprised in said text file (1100).

22. A method for storing information in a repository (1800), comprising the activities of:
receiving a text file (1100) comprising a plurality of records containing data in character string representative data format;
parsing a reference file (1200) to determine relationships, said relationships comprising key relationships;
storing data identifying said relationships in memory; and
storing said records comprised in said text file (1100) in a repository (1800) using said data identifying said relationships.

23. A method for storing information in a repository (1800), comprising the activities of:
receiving a text file (1100) comprising a plurality of records containing data in character string representative data format;
assigning new identifier values to uniquely identify individual records of said plurality of records, said assigned new identifier values being separate from record identifier values contained within said received records;
incorporating said new identifier values in corresponding individual records of said plurality of records to provide processed records;
storing said processed records in a repository (1800);
parsing a reference file (1200) to determine record related information, said record related information further comprising key information; and
storing said record related information in memory.

24. A method for storing information in a repository (1800), comprising the activities of:
receiving a text file (1100) comprising a plurality of records containing data in character string representative data format;
assigning new identifier values to uniquely identify individual records of said plurality of records, said assigned new identifier values being separate from record identifier values contained within said records as received;
incorporating said new identifier values in corresponding individual records of said plurality of records;
storing said records in a repository (1800); and
parsing a reference file (1200) to determine record related information; and
storing said record related information in memory.

25. A method for converting a database file to a text file (1100) comprising the activities of:
obtaining a database file;
for each record from the database file, transferring the record from the database file to a text file (1100) as a character string, each character string comprising data elements from the record; and
creating a reference file (1200) related to the database file, the reference file (1200) usable for parsing the text file (1100), the reference file (1200) comprising information related to the structure of the database file, the information comprising at least one key relationship.

26. The method of claim 25, wherein the reference file (1200) comprises metadata (1200).

27. A method for updating a composite database file comprising:
obtaining a second text file (1100) comprising a plurality of character strings, each character string corresponding to a record from a second original database file;
obtaining a composite database file, the composite database file created from character strings of a first text file (1100), each character string corresponding to a combination of data elements from a record, the record from a first original database file; and merging the second text file (1100) contents into the composite database file by providing character strings from the second text file (1100) to the composite database file.

28. The method of claim 27, further comprising:
obtaining a composite database structure file defining relationships in the composite database file;
obtaining a reference file (1200) relatable to the text file (1100), the reference file (1 200) comprising structural data describing records and fields from the text file (1100) and at least one key relationship; and
updating the composite data base structure file responsive to the reference file (1200).
